(19) United States
(12) Patent Application Publication
(10) Pub. No.: US 2012/0294343 A1
(43) Pub. Date: Nov. 22, 2012

(54) RF I/Q Modulator with Sampling Calibration System

(75) Inventors: Andrew M. Teetzel, Wilson, WY (US); Panagiotis Pete Pragastis, Los Gatos, CA (US); Charanbir S. Mahal, San Jose, CA (US)

(73) Assignee: Phase Matrix, Inc., San Jose, CA (US)

(21) Appl. No.: 13/108,786

(22) Filed: May 16, 2011

(51) Int. Cl. H04B 17/00

(52) U.S. Cl. 375/224

(57) ABSTRACT

A vector RF modulation system includes a sampling receiver that monitors modulator RF output and provides IF signals for a processor that calculates modulator calibration parameters.

### TECHNICAL FIELD

The disclosure is related to calibration systems for vector radio-frequency modulators.

### BACKGROUND

A radio-frequency (RF) modulator modulates a radio-frequency carrier wave with lower frequency information. A modulator in a transmitter at a typical AM (amplitude modulation) radio station, for example, modulates the amplitude of a radio frequency carrier of about 1 MHz with a voice or music signal in the audio frequency range of roughly 200 to 20,000 Hz.

Many different radio-frequency modulation schemes are in routine use. In general, modulation of both the amplitude and phase of radio wave is used to transmit information. Any combination of amplitude and phase modulation may be achieved by modulating in-phase (I) and quadrature (90-degree advanced, Q) components of a carrier wave. Specific modulation patterns may be represented in a plane formed by I and Q axes that measure the amplitude of in-phase and quadrature modulation, respectively.

In a cell phone, for example, a person's voice is converted to digital information that is encoded as symbols in the (I, Q) plane. Examples of such symbols include (1, 0), (0, 1) and (1, 1) which represent pure I modulation, pure modulation, and equal parts I and Q modulation, respectively. Because the symbols may be represented as vectors, an (I, Q) RF modulator is also referred to as a vector RF modulator. A vector modulator in a cell phone modulates a radio carrier wave according to (I, Q) symbol vectors representing voice information.

Vector RF modulators are used in a wide range of radio systems and test equipment. Optimum performance of a vector modulator depends in part on its ability to modulate a carrier wave according to I and Q inputs accurately. An (I, Q) input of (1, 1), for example should result in an RF output having (1, 1) modulation characteristics. But if errors are introduced, the output may actually have (0.95, 1.05) modulation, for example.

A vector RF modulator may include provisions for making calibration adjustments. The adjustments are made after receiving a known modulation signal with a dedicated receiver. Often the receiver and modulator are components of the same transmitting system. Two different kinds of receiver are often used for vector RF modulator calibration: direct detection and super-heterodyne. FIGS. 1A and 1B illustrate example frequency plans for direct detection and super-heterodyne receivers, respectively.

In FIGS. 1A and 1B “SIGNAL” indicates the modulated output from a vector RF modulator. “HARMONICS” are multiples of the signal frequency, while “NOISE” includes many kinds of random disturbances that appear in the spectrum. The purpose of a receiver in a calibration system for a vector RF modulator is to translate the modulator output signal to a lower frequency so that the modulation can be analyzed. Best results are obtained when the translation includes as little energy as possible from harmonics and noise.

In a direct conversion receiver, as represented by the frequency plan of FIG. 1A, a section of the spectrum near the signal frequency is translated to zero frequency (“DC”). In typical implementations, banks of capacitor-based lifters are switched in and out of the signal path to select a portion of the spectrum that contains the signal. These lifters are not very narrow in frequency, however, so inevitably a significant amount of noise accompanies the desired signal and cannot be separated from it. A DC low pass filter (“LPF”) eliminates some noise, but cannot remove noise close to the signal or from low-frequency sources. A direct conversion receiver is relatively inexpensive and is therefore commonly included as part of a calibration system with a vector RF modulator.

In a super-heterodyne receiver, as represented by the frequency plan of FIG. 1B, a tunable local oscillator (“LO”) signal is mixed with the signal to create an intermediate frequency (“IF”) where ƒ_{IF}=ƒ_{RE}−ƒ_{LO}. Here f_{IF}, f_{RF} and f_{LO} refer to the intermediate, signal and local oscillator frequencies, respectively. The intermediate frequency is chosen to be low enough for convenient conversion of signals in an analog-to-digital converter, but well above low-frequency noise sources. An IF band pass filter (“BPF”) can be made quite sharp in frequency, thus eliminating a great deal of noise. The super-heterodyne receiver offers high performance, but it is expensive. In particular, it is not easy to generate a high quality LO over a wide bandwidth at UHF and microwave frequencies. Thus super-heterodyne receivers are impractical to include as dedicated systems for vector RF modulator calibration.

What is needed is a vector RF modulator with a dedicated calibration system. The calibration system should include a receiver design that is less expensive than super-heterodyne, yet not suffer from the lack of selectivity of direct conversion.

### BRIEF DESCRIPTION OF THE DRAWINGS

FIGS. 1A and 1B illustrate example frequency plans for direct detection and super-heterodyne receivers, respectively.

FIG. 2 illustrates a frequency plan for a sampling receiver.

FIG. 3 is a conceptual block diagram of a system including a vector RF modulator with a dedicated sampling receiver and a processor.

FIG. 4 is a block diagram of a vector RF modulator with calibration inputs.

### DETAILED DESCRIPTION

A vector RF modulator with a sampling calibration system is now described. The system permits accurate calibration of I and Q modulation parameters over a wide bandwidth range. The system includes a sampling receiver which is less sensitive to noise than a direct-conversion receiver, but less expensive than a super-heterodyne receiver with a wide-range tunable LO.

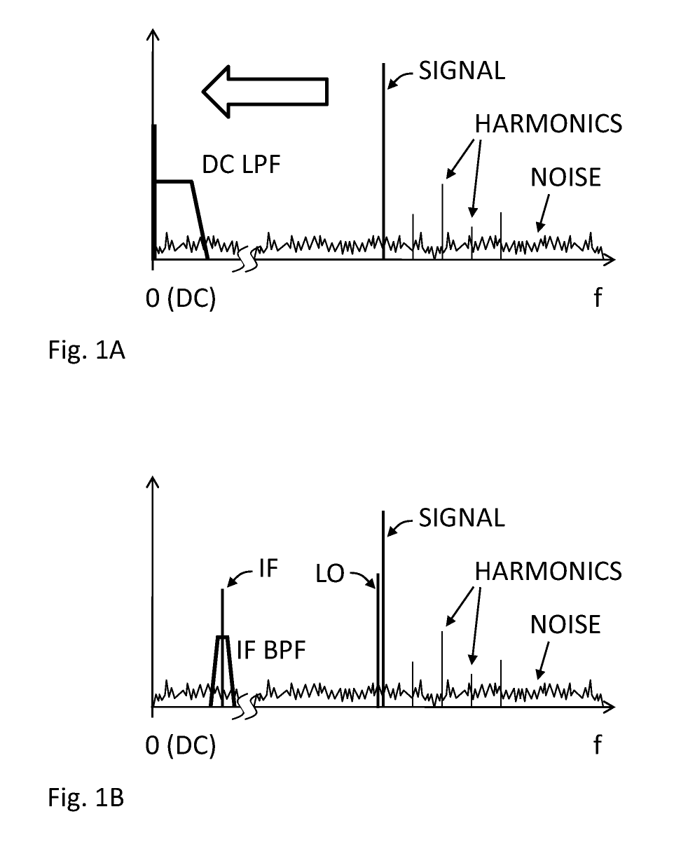

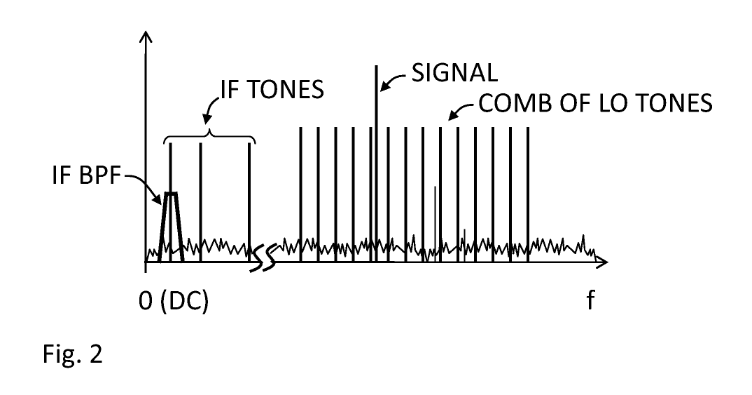

FIG. 2 illustrates a frequency plan for a sampling receiver. In FIG. 2 “SIGNAL” indicates the modulated RF signal output from a vector RF modulator. A sampling receiver generates a “comb” of LO frequencies (or “tones”) rather than a single LO frequency. The comb of LO tones is made by generating a large number of harmonics of a stable, LO frequency source. The use of a comb of LO tones is in stark contrast to the super-heterodyne design, represented by the frequency plan of FIG. 1B, where great care is taken to produce a single-frequency LO. (In FIGS. 1A, 1B and 2, the frequency scale is different on either side of the break.)

The comb of LO tones is mixed with the RF signal to produce a set of IF tones. An IF band pass filter selects one of the IF tones for analysis. The IF BPF may have a much narrower pass-band than RF filters typically used in direct conversion designs because it operates at a much lower frequency. Low-order harmonics of the RF signal that mix with tones in the comb of LO tones produce intermediate frequencies that lie outside the IF BPF pass-band.

As an example, consider a system in which the RF signal is at 10.0 GHz, the IF BPF is centered at 100 MHz and harmonics of a 505 MHz frequency source are used to generate a comb of LO frequencies. In the LO comb, the 20th harmonic of 505 MHz, which is 10.1 GHz, mixes with the 10.0 GHz RF signal to generate a 100 MHz IF. The second harmonic of the RF signal lies at 20.0 GHz. The closest frequency in the LO comb is the 40th harmonic of 505 MHz which is 20.2 GHz. Thus the IF tone corresponding to the second harmonic of the RF signal lies at 200 MHz which is well outside the pass-band of the IF BPF.

The IF BPF center frequency and the frequencies in the comb of the LO tones are normally fixed. Therefore when a vector RF modulator uses a sampling receiver in its calibration system, modulation characteristics are measured at discrete RF frequencies. In the example above, RF signals at . . . 8.990, 9.495, 10.000, 10.505, 11.105 GHz . . . etc. can be measured. The sampling receiver can operate over a wide range of frequencies as the range of LO tones can be made quite large, extending over tens of GHz.

Measurements of (I, Q) test vectors such as (1, 0), (0, 1), (−1, 1), etc. yield information that is used to calculate modulator calibration parameters at each frequency. RF modulator calibration parameters change slowly enough with frequency that interpolation may be used to find calibration parameters at in-between frequencies, e.g. between 9.495 GHz and 10.000 GHz in the example above.

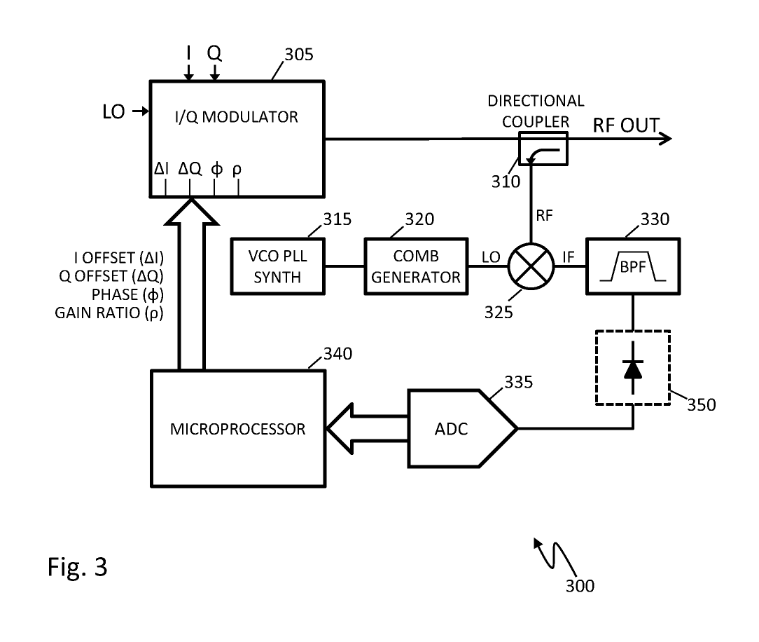

FIG. 3 is a conceptual block diagram of a system 300 including a vector RF modulator with a dedicated sampling receiver and a processor. In FIG. 3, a small portion of the output of vector RF modulator 305 is split off by directional coupler 310 and is input to mixer 325. Alternatives for directional coupler 310 include an RF SP2T switch or power divider/splitter. Modulator 305 has I and Q signal inputs, and an LO input. (The LO input of modulator 305 should not be confused with the LO input to mixer 325. The LO input of modulator 305 accepts an unmodulated RF carrier.) The modulator also has inputs for calibration parameters ΔI, ΔQ, φ and ρ. Mixer 325 is part of a sampling receiver which includes frequency source 315, comb generator 320, the mixer, and bandpass filter 330. The output of the bandpass filter is digitized by analog-to-digital converter (ADC) 335. Digital output from the ADC is sent to processor 340 which calculates modulator calibration parameters (ΔI, ΔQ, φ and ρ) that are sent to modulator 305. An optional detector 350 may be included to rectify the output of the bandpass filter before analog-to-digital conversion.

Frequency source 315 may be implemented, for example, as a voltage-controlled oscillator (VCO), phase-locked loop (PLL) synthesizer. (Alternative frequency sources include crystal oscillators or free-running voltage-controlled oscillators.) Comb generator 320 generates a set of harmonics of the single-frequency output of frequency source 315. Although any single-frequency source 315 may be used, modern VCOs offer low phase noise output which leads to clean harmonic signals in the comb generator output. Suitable comb generators may be based on step recovery diodes, non-linear transmission lines or other circuits. Mixer 325 mixes the comb of LO tones generated by comb generator 320 with the RF signal split off by directional coupler 310 to produce a comb of IF tones that is sent to bandpass filter 330. (Note: The sampling receiver may be realized in alternative forms as a number of techniques and sampling circuits are known in the industry for sampled mixing.) The filtered IF signal output of BPF 330 is sent to ADC 335. The ADC provides a digital representation of the IF signal. Finally, microprocessor 340, including associated memory and software, demodulates the IF signal and calculates modulator calibration parameters. If optional detector 350 is included, ADC 335 measures the rectified output of BPF 330, i.e. a DC signal. This reduces the number of IF signal samples needed and simplifies signal analysis.

The bandwidth of band-pass filter 330 is narrow enough to reject spurious mixer products derived from harmonics of the RF signal. However the bandwidth is not so narrow that it blocks a desired IF tone produced by mixing the RF signal with the nearest high harmonic in the comb of LO tones. Said another way, frequency source 315 is stable enough that frequency errors in its harmonics do not cause a desired IF tone to fall outside the IF BPF bandwidth.

Parameters calculated by processor 340 include I offset (ΔI), Q offset (ΔQ), phase (φ) and gain ratio (ρ). ΔI and ΔQ are DC offsets in I and Q, phase φ adjusts the nominal 90 degree phase difference between I and Q, and gain ratio ρ affects the relative gain of I and Q. An introduction to I and Q calibration calculations is given, for example, in “The Correction of I and Q Errors in a Coherent Processor” by F. E. Churchill et al., IEEE Transactions on Aerospace and Electronic Systems, v. AES-17, p. 131-137, January 1981, incorporated herein by reference.

Since calibration calculations are based on measurements of (I, Q) test vectors input to modulator 305, processor 340 requires information on which (I, Q) test vectors correspond to which data acquired by ADC 335. When interpolation between data measured at different frequencies is needed, then the processor requires information on the frequency of the LO input to the modulator (i.e. the RF carrier frequency). Data measured at different frequencies may be used to build an interpolation table or fit to a frequency response function for calibration parameters. The ability to measure RF modulation results for various (I, Q) test vectors over a wide range of frequencies effectively expands the useful range of modulator 305 by keeping the modulator calibrated within tight tolerances.

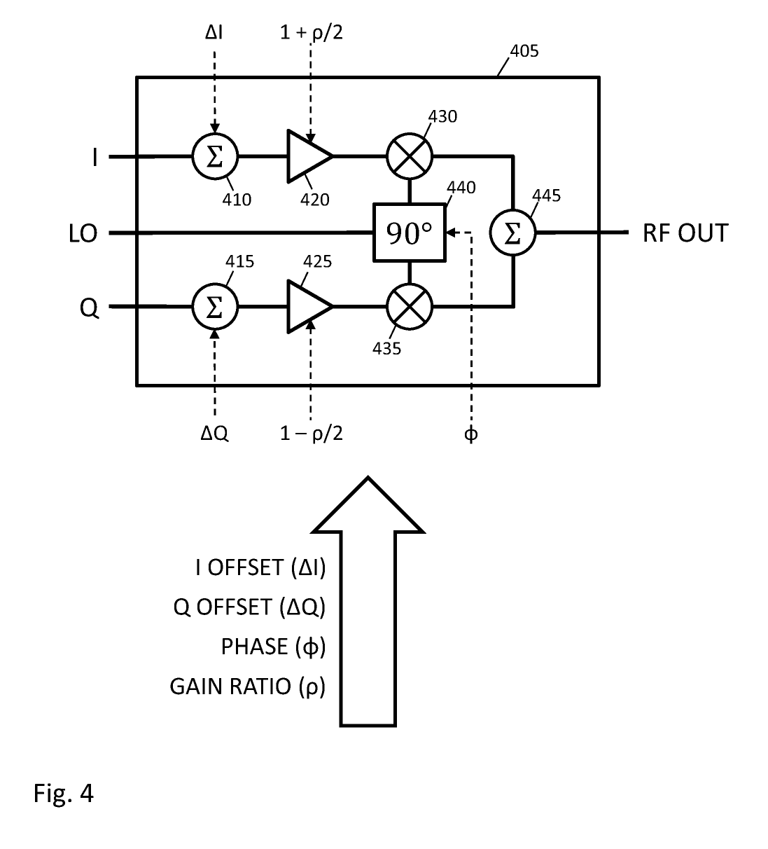

Once calibration parameters are calculated by the processor, they are sent to the modulator. FIG. 4 is a block diagram of a vector RF modulator with calibration inputs. In FIG. 4, modulator 405 is an example of one type of vector RF modulator. In modulator 405, summing amplifier 410 adds I offset, ΔI, to the I modulator input. The output of summing amplifier 410 is connected to the input of amplifier 420. The gain of amplifier 420 is proportional to one plus half the gain ratio, ρ. The output of amplifier 420 is mixed with an LO (i.e. RF carrier) signal in mixer 430. Similarly, summing amplifier 415 adds Q offset, ΔQ, to the Q modulator input. The output of summing amplifier 415 is connected to the input of amplifier 425. The gain of amplifier 425 is proportional to one minus half the gain ratio, ρ. The output of amplifier 425 is mixed with an LO (i.e. RF carrier) signal in mixer 435. The LO signal input to mixer 435 is delayed from the LO signal input to mixer 430 by a nominal 90-degree phase shift that is generated by phase shifter 440. Phase shifter 440 accepts phase input, φ, to permit corrections that make the actual phase shift as close to 90 degrees as possible. The outputs of mixers 430 and 435 are combined in sum amplifier 445 to generate the overall modulator RF output signal.

Other modulator architectures are possible. For example, complex rotations may be applied to I and Q signals to adjust phase before mixing with LO signals that have a fixed, nominal 90-degree phase relationship. Complex rotations are used to pre-compensate for the effect of actual I and Q LO signals that are not exactly 90-degrees apart. In general, any type of vector or (I, Q) modulator is suitable for use in a system with a sampling receiver as described above as long as the modulator has calibration inputs for I offset, Q offset, phase and gain ratio. Suitable modulators be assembled from discrete functional blocks (amplifiers, mixers, etc.) or integrated as complete systems, for example in a monolithic microwave integrated circuit.

A vector RF modulator with a sampling calibration system permits accurate calibration of I and Q modulation parameters over a wide bandwidth range. The system includes a sampling receiver which is less sensitive to noise than a direct-conversion receiver, but less expensive than a super-heterodyne receiver with a wide-range tunable LO. Since the sampling receiver is used to monitor an RF signal that is directly coupled from the RF output of a modulator, it is generally not subject to interfering signals that might otherwise reduce receiver performance.

The above description of the disclosed embodiments is provided to enable any person skilled in the art to make or use the disclosure. Various modifications to these embodiments will be readily apparent to those skilled in the art, and the principles defined herein may be applied to other embodiments without departing from the scope of the disclosure. Thus, the disclosure is not intended to be limited to the embodiments shown herein but is to be accorded the widest scope consistent with the principles and novel features disclosed herein.

What is claimed is:

1. A vector RF modulation system comprising:
a vector RF modulator having LO, I and Q inputs, and an RF output;
a sampling receiver coupled to the RF output of the modulator, the receiver having a band-pass filtered IF output; and,
a processor for calculating modulator calibration parameters based on the filtered IF output from the sampling receiver obtained in response to known (I, Q) test vector inputs to the modulator.

2. The system of claim 1, the calibration parameters including I offset, Q offset, phase and gain ratio.

3. The system of claim 1, the calibration parameters being applied to the modulator.

4. The system of claim 1, the processor further calculating modulator calibration parameters for a set of different modulator LO frequencies and storing the results in memory.

5. The system of claim 4, the processor further interpolating between calibration parameters determined at different modulator LO frequencies.

6. The system of claim 1 further comprising a detector that rectifies the band-pass filtered IF output.

7. The system of claim 1, the sampling receiver comprising a comb generator.

8. The system of claim 7, the comb generator comprising a step recovery diode.

9. The system of claim 7, the comb generator comprising a non-linear transmission line.

10. The system of claim 1, the sampling receiver comprising a voltage-controlled oscillator, phase-locked loop synthesizer.

11. The system of claim 1, the sampling receiver comprising a crystal oscillator.

12. A method for measuring calibration parameters in a vector RF modulation system comprising:
providing a vector RF modulator having LO, I and Q inputs, and an RF output;
providing a sampling receiver coupled to the RF output of the modulator, the receiver having a band-pass filtered IF output;
applying (I, Q) test vectors to the RF modulator I and Q inputs; and,
calculating I offset, Q offset, phase and gain ratio based on filtered IF output from the sampling receiver obtained in response to the (I, Q) test vectors.

13. The method of claim 12 further comprising:
applying the calculated I offset, Q offset, phase and gain ratio to the modulator.

14. The method of claim 12 further comprising:
rectifying the band-pass filtered IF output.

15. The method of claim 12 further comprising:
calculating modulator calibration parameters for a set of different modulator LO frequencies and storing the results in memory.

16. The method of claim 15 further comprising:
interpolating between calibration parameters determined at different modulator LO frequencies.

17. The method of claim 12, the sampling receiver comprising a comb generator.

18. The method of claim 17, the comb generator comprising a step recovery diode.

19. The method of claim 17, the comb generator comprising a non-linear transmission line.

20. The method of claim 12, the sampling receiver comprising a voltage-controlled oscillator, phase-locked loop synthesizer.

21. The method of claim 12, the sampling receiver comprising a crystal oscillator.
